(19) United States
(12) Patent Application Publication
(10) Pub. No.: US 2025/0241225 A1
(43) Pub. Date: Jul. 31, 2025

(54) TREATMENT DEVICE LIQUID DELIVERY SYSTEM

(71) Applicant: BASF Corporation, Florham Park, NJ (US)

(72) Inventor: Ronald Reichert, Florham Park, NJ (US)

(73) Assignee: BASF Corporation, Florham Park, NJ (US)

(21) Appl. No.: 18/853,987

(22) PCT Filed: Apr. 6, 2023
(86) PCT No.: PCT/US2023/065447

§ 371 Date: Oct. 3, 2024

Related U.S. Application Data
(60) Provisional application No. 63/329,672, filed on Apr. 11, 2022.

(51) Int. Cl. A01C 1/06; F04B 23/04; F04B 43/12

(52) U.S. Cl. CPC A01C 1/06; F04B 23/04; F04B 43/12

(57) ABSTRACT

A liquid delivery system for a treatment device includes first and second reservoirs (104) containing first and second liquids (106) and first and second positive displacement pumps (112) operably coupled to the first and second reservoirs (104), respectively. The first positive displacement pump (112) is configured to pump (200) the first liquid (106) therethrough at a first flow rate and the second positive displacement pump (114) is configured to pump (200) the second liquid (110) therethrough at a second flow rate. A motor (116) is operably coupled to the first and second positive displacement pumps (112) to drive simultaneous operation thereof.

This application claims the benefit of U.S. Provisional Application No. 63/329,672, filed Apr. 11, 2022, the contents of which are hereby incorporated by reference herein in its entirety.

### FIELD OF THE DISCLOSURE

The present disclosure generally relates to treatment device liquid delivery systems and, more particularly, to inoculant delivery systems for seed treatment devices.

### BACKGROUND

Inoculants can be applied to seeds to provide greater plant vitality and improved yield. Inoculants include bacteria to produce this effect. To increase effectiveness and longevity for the bacteria, an extender or enhancer including materials to support the bacteria can be mixed with the inoculant prior to application on the seeds. If the mixture of the extender and the inoculant is left too long, however, contamination organism growth can cause the mixture to become unusable or have reduced performance. Further complicating accurate delivery is that the proportion of inoculant to extender is uneven and the liquid properties are different.

### SUMMARY

In accordance with a first aspect, a liquid delivery system for a treatment device is disclosed that includes a first reservoir containing a first liquid, a first positive displacement pump operably coupled to the first reservoir and configured to pump the first liquid therethrough at a first flow rate, a second reservoir containing a second liquid, and a second positive displacement pump operably coupled to the second reservoir and configured to pump the second liquid therethrough at a second flow rate. The system further includes a motor operably coupled to the first and second positive displacement pumps to drive simultaneous operation thereof. Further, at least one of: the first flow rate and the second flow rate are different, the first liquid and the second liquid have different viscosities, or the first liquid and the second liquid have different flow characteristics.

In some examples, a treatment device (e.g., a seed treatment device) can include the liquid delivery system.

In accordance with a second aspect, a method for delivering a plurality of liquids to a treatment device is described that includes providing a first reservoir containing a first liquid fluidly connected to a first positive displacement pump and a second reservoir containing a second liquid fluidly connected to a second positive displacement pump, operating a motor operably coupled to the first positive displacement pump and the second positive displacement pump to drive simultaneous operation thereof to pump the first liquid at a first flow rate and the second liquid at a second flow rate, and wherein at least one of: the first flow rate and the second flow rate are different, the first liquid and the second liquid have different viscosities, or the first liquid and the second liquid have different flow characteristics.

### BRIEF DESCRIPTION OF THE DRAWINGS

FIG. 1 is a diagrammatic view of a liquid delivery system for a treatment device in accordance with the teachings of the present disclosure;

FIG. 2 is a sectional perspective view of an example assembly for the liquid delivery system of FIG. 1 including a motor, pumps, and tubing;

FIG. 3 is a diagrammatic view of an example pump for the liquid delivery system of FIG. 1;

FIG. 4 is a flowchart for liquid delivery to a treatment device in accordance with the teachings of the present disclosure; and

FIG. 5 is a graph showing pounds of seed per minute throughput for a treatment device.

### DETAILED DESCRIPTION

The liquid delivery systems described herein advantageously keep an inoculant and an associated extender separate prior to application to the seeds being treated. Other and/or additional liquids could alternatively be included. In some examples, the liquids could include seed treatment insecticide and a seed treatment coating, a seed treatment fungicide and a seed treatment insecticide, a seed treatment insecticide and a seed treatment fungicide, or a seed treatment nematicide and a seed treatment insecticide.

The systems utilize two or more positive displacement pumps, such as peristaltic pumps, to deliver liquids at differing flow rates to achieve a desired proportion relative to one another and/or to deliver liquids having differing viscosities/flow characteristics. The delivery systems can effectively pump liquids having a wide range of viscosities, such that the systems are largely agnostic to temperature and can be used during early-season treatments. Additionally, due to the configuration of the positive displacement pumps and separate supply reservoirs for the liquids, treatments can be paused or delayed for extended periods without compromising the liquids' stability, hygiene, and/or performance. This configuration can also be utilized for hazardous materials, as the system can be closed.

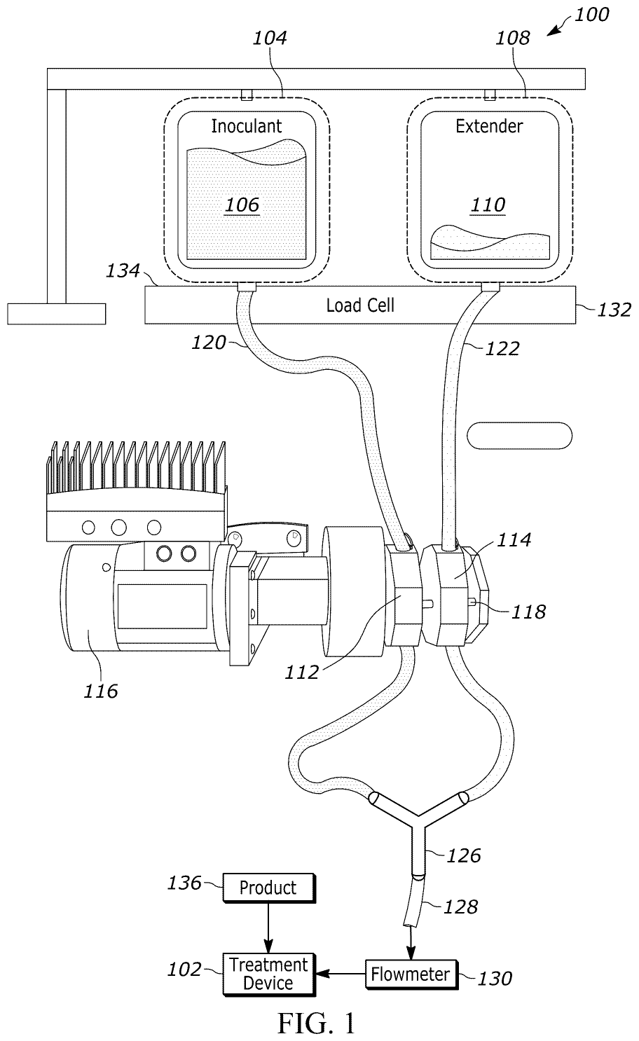

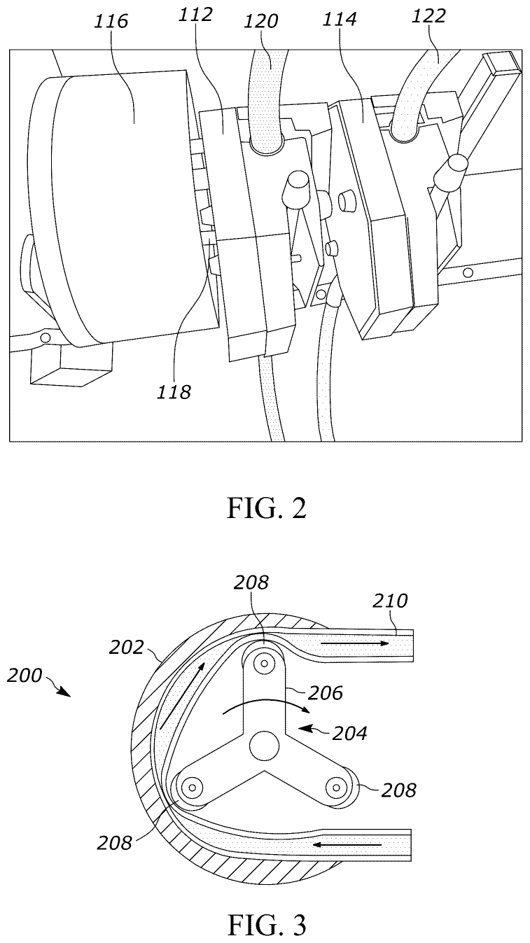

In one implementation as shown in FIGS. 1 and 2, a liquid delivery system 100 for a treatment device 102 includes a first reservoir 104 containing a first liquid 106 and a second reservoir 108 containing a second liquid 110. The system 100 further includes a first positive displacement pump 112 operably coupled to the first reservoir 104 and configured to pump the first liquid 106 therethrough at a first flow rate, and a second positive displacement pump 114 operably coupled to the second reservoir 108 and configured to pump the second liquid 110 therethrough at a second flow rate. The system 100 further includes a motor 116 operably coupled to both of the first and second positive displacement pumps 112, 114 to drive simultaneous operation thereof. The system 100 advantageously can accommodate liquids having different viscosities or flow characteristics and/or the first and second flow rates can be different.

The liquid delivery system 100 can be a standalone component, a kit for a treatment device 102, or a component of a treatment device 102. In one example, the treatment device 102 can be a seed treatment device.

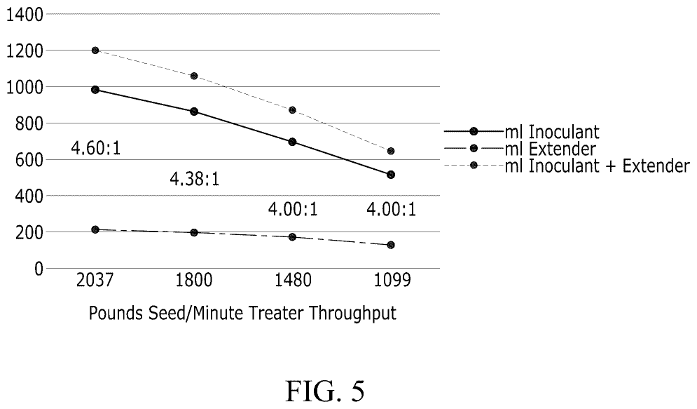

In one example, the motor 116 drives operation of both the first and second positive displacement pumps 112, 114, while the pumps 112, 114 have different element configurations to produce different flow rates. The differing flow rates allows the system 100 to deliver the first and second liquids 106, 108 at a desired proportion. For example, the pumps 112, 114 can be configured to output at a ratio of optimally between 3:1 to 6:1, 4:1 to 5:1, 4:1 to 4.6:1, 4.3:1 to 4.5:1, or about 4.4:1, or about 4.375:1. It will be understood that these ratios are exemplary and that other ratios are included within the scope of this disclosure for a wide variety of liquid products. In one example, FIG. 5 illustrates a graph showing different ratios of inoculant and extender across a range of seed throughput values. As shown, the ratios range from 4.00:1 to 4.60:1 as seed throughput increases. For a typical seed throughput of 1800 pounds/minute, the ratio would be about 4.38:1.

As shown, the motor 116 can include a drive shaft 118 extending outwardly therefrom and the first and second positive displacement pumps 112, 114 can be stacked on the drive shaft 118 to be driven thereby. Additional pumps for additional liquids can be included as needed or desired.

In some examples, the first and second positive displacement pumps 112, 114 can be first and second peristaltic pumps. An example peristaltic pump 200, suitable for use as the first and second positive displacement pumps 112, 114 with suitable configurations, is shown in FIG. 3. As shown, the peristaltic pump 200 includes a housing 202 containing a pump element 204 rotatably disposed therein. In one example, the pump element 204 includes a rotor 206 and two or more rollers 208 coupled to the rotor 206. In the illustrated example, the pump element 204 includes three rollers 208. If desired, sliding components can be utilized instead or in addition to rollers. A tube 210 extends through the peristaltic pump 200 to be engaged by the pump element 204. The rollers 208 pinch the tube 210 against the housing 202 of the pump 200 to thereby prevent fluid flow therepast. As the rotor 206 rotates, suction is created and fluid is driven through the tube 210, as commonly understood.

With the above configuration, the system 100 can also include a first tube 120 extending from the first reservoir 104 through the first peristaltic pump 112 and a second tube 122 extending from the second reservoir 108 through the second peristaltic pump 114. To achieve different flow rates, the internal diameters of the first and second tubes 120, 122 can be different. For example, the first tube 120 can have a 0.382″ internal diameter and the second tube 122 can have a 0.157″ internal diameter. The elements of the peristaltic pumps 112, 114 engage the first and second tubes 120, 122 to drive the fluids 106, 110 therethrough. Advantageously, when not in use, elements (e.g., element 204) of the pumps 112, 114 can effectively seal the first and second tubes 120, 122 to prevent fluid flow therethrough. This isolates the liquids 106, 110 within their respective reservoirs 104, 108 and tubes 120, 122, and allows the first and second fluids 106, 110 to be viable for much longer periods than compared with fluids combined in a mixture. With this configuration, the operation of the system 100 can be stopped or paused by stopping operation of the motor 116 for a predetermined amount of time without compromising the fluids 106, 110. For example, the predetermined amount of time can be up to 24 hours or more than 24 hours.

As discussed above, the first and second liquids 106, 110 can have different viscosities. For example, the viscosities of the first and second liquids 106, 110 can be between 0 and 2000 centipoise or between 0 and 1000 centipoise. In one example, the first liquid 106 can be an inoculant and the second liquid 110 can be an extender or enhancer for the inoculant. In some examples, the inoculant can be PPST 120+; a rhizobial soybean liquid inoculant, such as Vault® or Nodulator®, and so forth.

The downstream delivery of the first and second liquids 106, 110 can have any suitable form. For example, the first and second tubes 120, 122 can be coupled to a Y connector 126 to join the flows of the first and second liquids 106, 110 together and a single delivery tube 128 can deliver the combined, mixed flow to an outlet location/treatment device 102, such as for a seed treatment device. Alternatively, the first and second tubes 120, 122 can be run to the outlet location/treatment device 102.

The system 100 can be configured to monitor and measure the amount of the first and second fluids 106, 110 dispensed through the first and second pumps 112, 114, respectively. In one example, a flow meter or other suitable flow sensor 130 can be operably coupled to the delivery tube 128 to measure a flow rate of the combined flow. Alternatively or additionally, flow meters or other suitable flow sensors 130 can be operably coupled to the first and second tubes 120, 122 to measure flow rates of the first and second liquids 106, 110, respectively.

In another example, the system 100 can include a load cell 132 having a support surface 134 and the first and second reservoirs 104, 108 can be disposed on the support surface 134, such that the load cell 132 can measure a loss in weight thereof. The loss in weight can be coordinated with a product 136, such as seeds, dispensed into the treatment device 102 to control an amount of the first and second fluids 106, 110 being dispensed accordingly.

The first and second reservoirs 104, 108 can have any suitable shape and configuration. The reservoirs 104, 108 can have flexible volumes. The reservoirs 104, 108 can be configured to contain the first and second liquids 106, 110 in a sterile state. For example, the reservoirs 104, 108 can be closed and/or sealed bladders or bags. Other containers, such as drums, buckets, bags, and so forth, can also be utilized. The first and second reservoirs 104, 108 can be hung, mounted, or otherwise disposed on a stand assembly 138. The stand assembly 138 can be configured to position the first and second reservoirs vertically above the first and second pumps 112, 114. Suitable vertical positioning of the stand assembly 138 relative to the first and second pumps 112, 114 can provide for increased dosing efficiency via a gravity assist dependent on viscosities and/or application rate ranges.

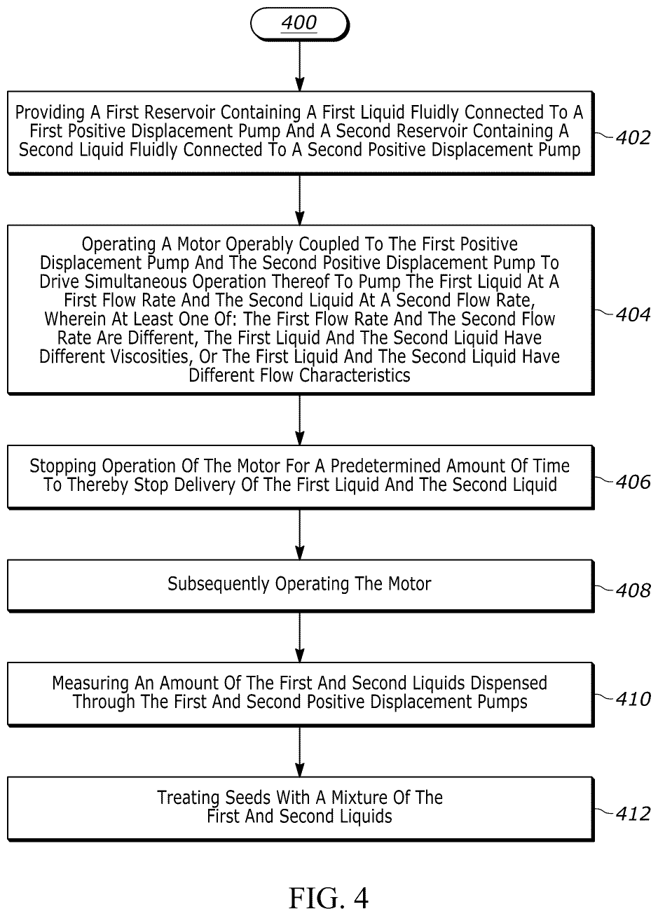

An example method 400 for delivering a plurality of liquids to a treatment device is shown in FIG. 4. The method 400 includes, in a first step 402, providing a first reservoir (e.g., first reservoir 104) containing a first liquid (e.g., first liquid 106) fluidly connected to a first positive displacement pump (e.g., first positive displacement pump 112) and a second reservoir (e.g., second reservoir 108) containing a second liquid (e.g., second liquid 110) fluidly connected to a second positive displacement pump (e.g., second positive displacement pump 114). In a second step 404, the method 400 includes operating a motor (e.g., motor 116) operably coupled to the first positive displacement pump and the second positive displacement pump to drive simultaneous operation thereof to pump the first liquid at a first flow rate and the second liquid at a second flow rate. In the second step, at least one of: the first flow rate and the second flow rate are different, the first liquid and the second liquid have different viscosities, or the first liquid and the second liquid have different flow characteristics.

In some examples, the method 400 can further include, in a third step 406, stopping operation of the motor for a predetermined amount of time to thereby stop delivery of the first liquid and the second liquid and, in a fourth step 408, subsequently operating the motor.

In some examples, the method 400 can further include, in a fifth step 410, measuring an amount of the first and second liquids dispensed through the first and second positive displacement pumps and/or, in a sixth step 412, treating seeds with a mixture of the first and second liquids.

### Examples

A test was conducted of a system utilizing two pump heads mounted on the driveshaft of a motor in accordance with some examples of the above disclosure. The test simulated the simultaneously feeding of an inoculant and an extender to a seed treatment device. Tables 1 and 2 provides current application rates for the inoculant and extender, with Table 1 showing values corresponding to fl. oz. per cwt and Table 2 showing values corresponding to customer-side fl. oz. per 140K unit.

TABLE 1
Current Application Rate as fl oz/cwt

| | | | | | Mix |
|---|---|---|---|---|---|
| | gm/ml | ml/100 kg | gm/100 kg | fl oz/cwt | Ratio |
| Inoculant | 1.02 | 109 | 111.29 | 1.67 | 3.52 |
| Extender | 1.20 | 31 | 37.14 | 0.48 | 1.00 |
| Total Mix | 1.060 | 140 | 148.43 | 2.15 | NA |

TABLE 2
Current Application Rate as Customer
Applies Product - fl oz/140K unit

| | | mg | | | Mix |
|---|---|---|---|---|---|
| | gm/ml | product/seed | fl oz/unit | ml/unit | Ratio |
| Inoculant | 1.021 | 0.1679 | 0.778571 | 23.03 | 3.52 |
| Extender | 1.198 | 0.0560 | 0.221429 | 6.55 | 1.00 |
| Total Mix | 1.04 | 0.2197 | 1 | 29.57 | NA |

Table 3 shows three different sizes of tube inner diameter utilized for the extender flowing through pump head number 2. The tube inner diameter utilized for the inoculant flowing through pump head number 1 remained the same. As shown, varying the tube inner diameters relative to one another results in different fluid ratios.

TABLE 3
Pump Element Size and Product Ratio Achieved

| | Pump Head 1 | Pump Head 2 | Inoculant to |
|---|---|---|---|
| | Inoculant | Extender | Extender Ratio |
| Element ID | 0.382 | 0.125 | 8.4:1 |
| Element ID | 0.382 | 0.157 | 4.375:1 |
| Element ID | 0.382 | 0.189 | 2.48:1 |

Tables 4 and 5 illustrate the dosages resulting from three tests utilizing the three tube inner diameter combinations shown in Table 3 showing values similar to Tables 1 and 2, discussed above. While none of the combinations provided the exact ratio of inoculant to extender currently used, the use of the 0.157″ inner diameter tube for the extender provided the ratio most similar to the current ratio. It is believed that the 4.375:1 ratio obtained with the 0.157″ inner diameter has the potential to provide the same or slightly better on seed survival (OSS) as the current application ratio.

TABLE 4
Dosage as fl oz/cwt

| Total fl | Inoculant fl | Inoculant % | extender fl | extender % |
|---|---|---|---|---|
| oz/cwt | oz/cwt | of Target | oz/cwt | of Target |
| 2.15 | 1.92 | 114.92% | 0.23 | 48.10% |
| 2.15 | 1.75 | 104.68% | 0.40 | 84.13% |
| 2.15 | 1.53 | 91.65% | 0.62 | 129.94% |

TABLE 5
Dosage as ml per 140K Unit

| Total | Inoculant | Inoculant % | extender | extender % |
|---|---|---|---|---|
| ml/unit | ml/unit | of Target | ml/unit | of Target |
| 29.57 | 26.42 | 114.76% | 3.15 | 48.04% |
| 29.57 | 24.07 | 104.53% | 5.50 | 84.01% |
| 29.57 | 21.07 | 91.52% | 8.50 | 129.76% |

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A liquid delivery system for a treatment device, the liquid delivery system comprising:
a first reservoir containing a first liquid;
a first positive displacement pump operably coupled to the first reservoir and configured to pump the first liquid therethrough at a first flow rate;
a second reservoir containing a second liquid;
a second positive displacement pump operably coupled to the second reservoir and configured to pump the second liquid therethrough at a second flow rate; and
a motor operably coupled to the first and second positive displacement pumps to drive simultaneous operation thereof;
wherein at least one of: the first flow rate and the second flow rate are different, the first liquid and the second liquid have different viscosities, or the first liquid and the second liquid have different flow characteristics.

2. The liquid delivery system of claim 1, wherein the motor comprises a drive shaft; and the first and second positive displacement pumps are stacked on the drive shaft to be driven thereby.

3. The liquid delivery system of claim 1, wherein the first and second positive displacement pumps comprise first and second peristaltic pumps.

4. The liquid delivery system of claim 3, further comprising a first tube extending from the first reservoir through the first peristaltic pump and a second tube extending from the second reservoir through the second peristaltic pump, the first and second tubes having different internal diameters.

5. The liquid delivery system of claim 4, wherein elements of the first and second peristaltic pumps engage the first and second tubes, respectively, such that, when not in operation, the elements stop fluid flow through the first and second tubes, isolating the first liquid within the first reservoir and the first tube and the second liquid within the second reservoir and the second tube.

6. The liquid delivery system of claim 4, further comprising:
a Y connector coupled to the first and second tubes; and
a delivery tube coupled to the Y connector and configured to receive the combined flow of the first and second tubes.

7. The liquid delivery system of claim 6, further comprising a flow meter configured to measure a flow rate of the combined flow of the first and second tubes.

8. The liquid delivery system of claim 1, further comprising a load cell having a support surface; the first and second reservoirs disposed on the support surface for the load cell to measure a loss in weight thereof.

9. The liquid delivery system of claim 1, wherein the first and second liquids have different viscosities.

10. The liquid delivery system of claim 9, wherein the viscosities of the first and second liquids are between 0 and 2000 centipoise.

11. The liquid delivery system of claim 9, wherein the viscosities of the first and second liquids are between 0 and 1000 centipoise.

12. The liquid delivery system of claim 1, wherein the first liquid comprises an inoculant and the second liquid comprises an extender.

13. The liquid delivery system of claim 1, wherein the first and second reservoirs comprise first and second bladders.

14. A treatment device comprising the liquid delivery system of claim 1.

15. The treatment device of claim 14 comprising a seed treatment device.

16. A method for delivering a plurality of liquids to a treatment device, the method comprising:
providing a first reservoir containing a first liquid fluidly connected to a first positive displacement pump and a second reservoir containing a second liquid fluidly connected to a second positive displacement pump;
operating a motor operably coupled to the first positive displacement pump and the second positive displacement pump to drive simultaneous operation thereof to pump the first liquid at a first flow rate and the second liquid at a second flow rate;
wherein at least one of: the first flow rate and the second flow rate are different, the first liquid and the second liquid have different viscosities, or the first liquid and the second liquid have different flow characteristics.

17. The method of claim 16, further comprising:
stopping operation of the motor for a predetermined amount of time to thereby stop delivery of the first liquid and the second liquid; and
subsequently operating the motor.

18. The method of claim 17, wherein the predetermined amount of time comprises at least 24 hours.

19. The method of claim 16, further comprising treating seeds with a mixture of the first and second liquids.

20. The method of claim 16, wherein operating the motor coupled to the first positive displacement pump and the second positive displacement pump comprises rotating a drive shaft of the motor to drive elements of a first peristaltic pump and a second peristaltic pump stacked on the drive shaft.

21. The method of claim 16, further comprising measuring an amount of the first and second liquids dispensed through the first and second positive displacement pumps.
